(19) United States
(12) Patent Application Publication
(10) Pub. No.: US 2010/0149965 A1
(43) Pub. Date: Jun. 17, 2010

(54) APPARATUS AND METHOD FOR RESTORING NETWORK CONNECTED WITH USERS HAVING DIFFERENT RECOVERY REQUIREMENTS

(76) Inventors: Eui-suk Jung, Daejeon-si (KR); Jea-hoon Yu, Daejeon-si (KR); Byoung-whi Kim, Daejeon-si (KR); Jai-sang Koh, Daejeon-si (KR); Dong-min Seol, Daejeon-si (KR); Hong-shik Park, Daejeon-si (KR); Mi-sun Ryu, Daejeon-si (KR); Ji-yong Park, Daejeon-si (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/608,916

(22) Filed: Oct. 29, 2009

(30) Foreign Application Priority Data
Dec. 12, 2008 (KR) 10-2008-0126696
Jul. 30, 2009 (KR) 10-2009-0070274

(51) Int. Cl. G06F 11/00

(52) U.S. Cl. 370/216

(57) ABSTRACT

A method of restoring a target network to which users having different recovery requirements are connected is provided. The method includes analyzing network components including availability information of each user and parameters reflecting characteristics of the target network; and determining optimized restoration architecture for the target network based on the result of the analysis. Accordingly, when failure occurs in a network to which various subscribers having different recovery requirements are connected, the network can be promptly recovered from the failure.

### CROSS REFERENCE TO RELATED APPLICATIONS

This application claims the benefit under 35 U.S.C. §119(a) of Korean Patent Application Nos. 10-2008-0126696, filed on Dec. 12, 2008, and 10-2009-0070274, filed on Jul. 30, 2009, the disclosures of which are incorporated herein by reference in their entireties for all purpose.

### BACKGROUND

1. Field

The following description relates to a network maintenance method, and more particularly, to a method of restoring a target network to which various user terminals having different recovery requirements are connected.

2. Description of the Related Art

In a conventional subscriber network, a network operator can provide subscribers with different quality of services according to a service level of the corresponding subscriber. Generally, different types of networks are individually run, for example an enterprise network for users having high specification requirements, a platinum network such as a banking network, and a bronze network for users having low specification requirements.

In this case, although a new bronze network user near a platinum network having a higher availability, it should be connected to a bronze network.

Recently, constant attempts have been made to share a transmission link portion between various types of networks in order to reduce network operating costs. As a result, the importance of an integrated network operation scheme which satisfies various service requirements of users is increasing.

In a conventional restoration architecture scheme for satisfying recovery requirements of different users in a single network, only a portion in which optical network units (ONUs) are shared is dualized. In another scheme, all parts inside a passive optical network (PON) are dualized. However, these schemes do not reflect different requirements of various users, and is only applied in the same manner to all users.

### SUMMARY

Accordingly, in one aspect, there is provided a network operation method which can satisfy different recovery requirements of various types of networks.

In one general aspect, there is provided a method of restoring a target network to which users having different recovery requirements are connected, the method including: analyzing network components including availability information of each user and parameters reflecting characteristics of the target network; and determining optimized restoration architecture for the target network based on the result of the analysis.

The determining of the optimized restoration architecture may include transforming multiplication of availabilities of individual components which form the target network into a relational expression with respect to a sum of availability of each user and selecting the optimized restoration architecture based on a value obtained from the relational expression.

In another general aspect, there is provided an apparatus for restoring a target network to which users having different recovery requirements are connected, the apparatus including: a network analyzing unit to analyze network components including availability information of each user and parameters reflecting characteristics of the target network; and an architecture determining unit to determine values necessary for designing optimized restoration architecture for the target network based on the result of the analysis.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a diagram illustrating a network restoration system according to an exemplary embodiment.

FIG. 2 is a block diagram illustrating a network restoration apparatus according to an exemplary embodiment.

FIG. 3 is a diagram illustrating an example of target network architecture for network restoration according to an exemplary embodiment.

FIG. 4 is a diagram illustrating an example of network architecture designed by a network restoration apparatus according to an exemplary embodiment.

FIG. 5 is a flowchart illustrating a network restoration method according to an exemplary embodiment.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

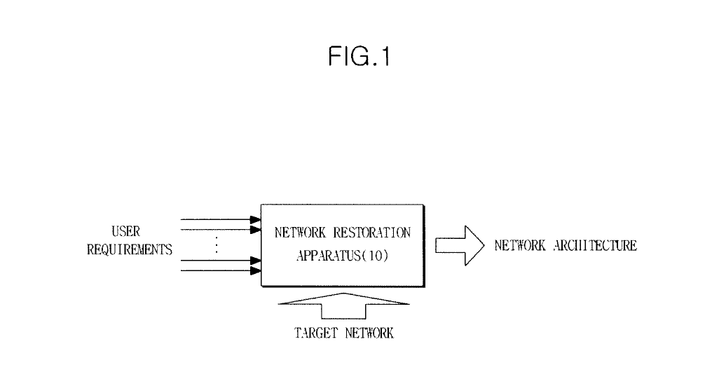

FIG. 1 is a diagram illustrating a network restoration system according to an exemplary embodiment. As shown in FIG. 1, when a target network is decided and requirements for availability of subscribers of the target network are determined, a network restoration apparatus 10 according to an exemplary embodiment can identify a restoration architecture for the target network. In this case, the target network may be a subscriber network that has connections between specific routes. Parameters indicating reliability of the network may include mean time to failure, reliability, and availability.

The availability is defined as a probability of properly performing a requested function at a predetermined time or for a predetermined period of time under given conditions. Thus availability can be considered as a proper parameter for a system having restoration architecture.

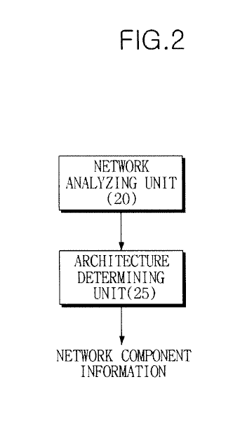

FIG. 2 is a block diagram illustrating a network restoration apparatus according to an exemplary embodiment.

The network restoration apparatus may be implemented in a network management system (NMS).

In the exemplary embodiment, the network restoration apparatus includes a network analyzing unit 20 and an architecture determining unit 25.

The network analyzing unit 20 analyzes network architecture elements. Here, the network architecture elements to be analyzed may be components or equipment in the network. Levels of components are determined according to design. In the exemplary embodiment, the network analyzing unit 20 analyzes the configuration components to build a table showing characteristics of configuration components and roles of the components.

The network analyzing unit 20 analyzes the network components such that an initial connection between network components can be established, maintained, or released and information of each network component can be maintained. Also, through the analysis of the network components, events occurring in the network can be managed. The event management is performed by a single control entity or by several control entities that share the task for quick processing in a large network.

More specifically, the network analyzing unit 20 analyzes each of the network components in more detail. First, the network analyzing unit 20 may analyze unique characteristics of the components. Accordingly, a network manager can keep track of equipment present in its own system. For example, the maximum number of wavelengths that the system can use, the number of currently available wavelengths, and operation of a used optical amplifier need to be maintained in a terminal of a wavelength division multiplexing (WDM) system. In addition, change of system configuration may require change of an optical path, or may require reconfiguration of network topology according to a manager's need.

In the exemplary embodiment, information on characteristics of the configuration component may include a price of the component and information on reliability of the component. The information on reliability may be two types of information. One is Mean Time to Failure (MTTF) that is average time until a failure occurs in a component. MTTF is a time until a component is first replaced with a new one, and is the same as an operating life span of the component. The other type of information is Mean Time to Repair (MTTR) which is the time that a component takes to recover from any failure. From these two types of information, availability of a component is obtained. The price information can be utilized for more economical design.

The network analyzing unit 20 analyzes relations between components. In other words, the network analyzing unit 20 manages tasks to establish connections between the network components, maintains a track continuously and returns resources for another connection if one connection does not need to remain valid. For example, in a WDM system, the above tasks may enable connection and/or release of an optical path.

The information regarding analysis of component relations may be information indicating topology of a network. The component relation information is defined as an effect factor (EF), and indicates the number of users involved with the component. That is, a value of EF shows how many users the component is affecting. A component that more users share has a higher EF value. For example, a component affecting only one user has an EF value of 1.

In addition, the price information of each component may be calculated by using the EF. The reflection of the price information of the component can produce relatively economic design.

The architecture determining unit 25 arranges pieces of data for optimized restoration architecture using the result of analysis from the network analyzing unit 20. In the exemplary embodiment, the architecture determining unit 25 may select restoration architecture optimized by use of a mathematical programming scheme, a heuristic scheme, or a meta-heuristic scheme.

The mathematical programming scheme, which is to obtain an optimal value, involves a large amount of calculation and is difficult to be used to formulate a realistic matter since constraints should be represented by a linear equation. On the other hand, the heuristic scheme which is for obtaining a realistically acceptable solution instead of the best solution within limited time duration requires methods for obtaining solutions of individual problems. Therefore, in the heuristic scheme, there is no standardized method, but various methods can be sought for solving different problems.

To compensate for such drawbacks of the heuristic scheme, a meta-heuristic scheme has been introduced and is widely used. The meta-heuristic scheme is a standardized method, which is a higher-level heuristic scheme and can be employed to wide range of problems.

Generally, the mathematical programming scheme has a form as follows:

Minimize f(x)

Subject to gᵢ(x)≧bᵢ; i=1, . . . , m

Here, ƒ(•) and gᵢ(•) are linear functions. Thus, the mathematical programming scheme can provide the optimal value. However, as described above, this scheme requires a great amount of calculation and needs to form a linear objective function with respect to constraints in order to obtain a solution. Therefore, it is difficult to model the actual phenomenon with this scheme. When applying the mathematical programming scheme, the objective function ƒ(•) aims to minimize the cost invested for the network in the current exemplary embodiment. Additionally, since satisfaction of availability of a user is requirement for network optimization, the availability is represented as the constraint. Topology can be represented by an EF value.

The availability of the whole system may be achieved from a connection form of components related to the system. If the components involved with the system are connected together in serial, the availability of the whole system may be obtained by multiplication of availability of each component

$$( {A}_{serial} = {A}_{1} {A}_{2} {A}_{3} … {A}_{x} = {\prod }_{i = 1}^{y} {A}_{j} ) ,$$

or if the components are connected in parallel, the availability of the whole system may be obtained by

$${A}_{parallel} = 1 - {\prod }_{i = 1}^{y} ( 1 - {A}_{i} ) .$$

Here, since the availability, as a constraint, is represented by a non-linear expression, the optimization value cannot be achieved. For using user availability as a constraint,

$${\prod }_{i = 1}^{n} {A}_{i} \approx 1 - {\sum }_{i = 1}^{n} {U}_{i}$$

is given. Accordingly, the multiplication of the availability of each related component can be represented by the sum of the user availabilities. According to the current exemplary embodiment, this expression is applied to an optimization method, and thus pieces of information on availability which differs with user are reflected so that optimized network architecture can be designed.

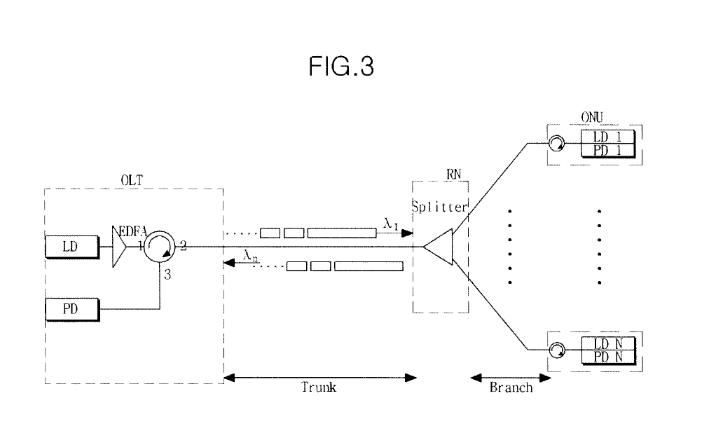

FIG. 3 is a diagram illustrating an example of target network architecture for network restoration according to an exemplary embodiment. The network shown in FIG. 3 is a general Ethernet passive optical network (EPON).

As shown in FIG. 3, in the EPON, an optical line terminator (OLT) connected to a network is manually connected with a plurality of optical network units (ONUs) 120a, 120b, and 120c through an optical splitter. In the EPON, unlike an asynchronous transfer mode (ATM)-PON, data is transmitted in the same unit as a conventional Ethernet frame, and an uplink frame and a downlink frame are transmitted over different frequencies.

In this case, users belonging to the target network have different availability levels as shown in table 1 below.

TABLE 1

| Level | Object availability | User |
|---|---|---|
| Platinum | 0.99999 | 1 |
| Gold | 0.9999 | 2 |
| Silver | 0.999 | 3 |
| Bronze | 0.99 | 4 |

As seen in table 1, levels including platinum, gold, silver, and bronze can be assigned to users according to the order of the object availability. The levels may vary with a service rate of the user or network access reliability.

Furthermore, a result of analysis on the network components by the network analyzing unit 20 may be represented as shown in Table 2 below.

TABLE 2

| | | | | Cost | Cost | MTTF | |
|---|---|---|---|---|---|---|---|
| | | EF | ea | ($/ea) | ($/co) | (/10\hat{ }9h) | MTTR |
| OLT | TRx | 4 | 1 | 100 | 25 | 4311 + 10867 | 2 |
| | EDFA | 4 | 1 | 600 | 150 | 5 * 10⁷ | 2 |
| | Circualtor | 4 | 1 | 300 | 75 | 10⁴ | 2 |
| ODN | T(/15 km) | 4 | 1 | 450 | 112.5 | 16500 | 12 |
| | SP | 4 | 1 | 40 | 10 | 10⁴ | 2 |
| | B(/5 km) | 1 | 1 | 150 | 150 | 5500 | 12 |
| ONU | TRX | 1 | 4 | 100 | 100 | 4311 + 10867 | 2 |
| | Circulator1 | 1 | 4 | 2 | 2 | 10⁴ | 2 |

The architecture determining unit 25 may produce optimized network architecture data using the data of Tables 1 and 2 as shown in table 3 below.

TABLE 3

| Availability Level | Platinum | Gold | Silver | Bronze |
|---|---|---|---|---|
| Subscriber | 1 | 2 | 3 | 4 |

| | | |
|---|---|---|
| OLT | TRX | 2 |
| | EDFA | 2 |
| | Circulator | 2 |
| ODN | T(/15 km) | 2 |
| | SP | 2 |

| | | | | | |
|---|---|---|---|---|---|
| | B(/5 km) | 2 | 1 | 1 | 1 |
| ONU | TRX | 2 | 2 | 1 | 1 |
| | Circulator | 2 | 2 | 2 | 1 |

The architecture determining unit 25 determines items of architecture data necessary for the network architecture according to the availability level of the ONU. The architecture data may include the numbers of light emitting units, light receiving units and circulators of the ONU.

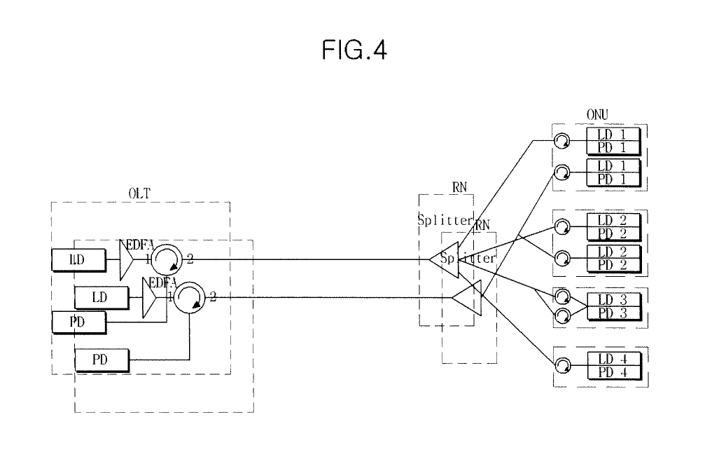

FIG. 4 is a diagram illustrating an example of network architecture designed by a network restoration apparatus according to an exemplary embodiment. The network architecture in FIG. 4 is designed based on network architecture data as shown in Table 3. That is, network architecture that optimizes availability of the whole system can be designed by reflecting availability data which differs with user based on the architecture data.

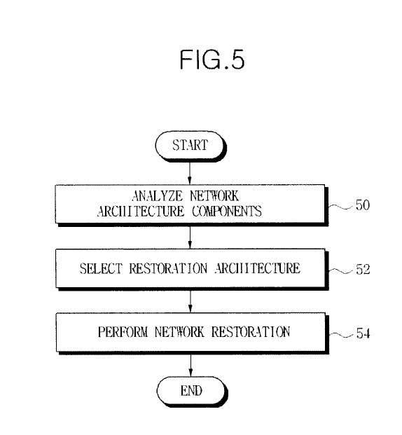

FIG. 5 is a flowchart illustrating a network restoration method according to an exemplary embodiment. Referring to FIG. 5, first network architecture components, each containing user availability information and parameters reflecting characteristics of a target network, are analyzed (operation 50). The parameters reflecting characteristics of a target network may contain unique component information including price information and reliability information of each network architecture component. The reliability information may be generated based on MTTF of a component which cannot be recovered from failure and MTTR of a recoverable component.

Based on the analysis result, optimized restoration architecture of the target network is determined (operation 52). The determination of the optimized restoration architecture may be performed based on obtained availability information of the whole system. In addition, by reflecting price information of each component, economically optimized network architecture can be designed.

To determine the optimized network architecture, any of a mathematical programming scheme, a heuristic scheme, or a meta-heuristic scheme is performed, and there is not limitation in methods of determining the optimized network architecture.

In the current exemplary embodiment, the availability of the whole system may be implemented by connection formation of components related to the system. If the components are connected in series, the availability of the whole system can be represented by multiplication of each component

$$( {A}_{serial} = {A}_{1} {A}_{2} {A}_{3} … {A}_{x} = {\prod }_{i = 1}^{y} {A}_{j} ) ,$$

or if the components are connected in parallel, the availability of the whole system may be obtained by

$${A}_{parallel} = 1 - {\prod }_{i = 1}^{y} ( 1 - {A}_{i} ) .$$

Here, since the availability, as a constraint, is represented by a non-linear expression, the optimization value cannot be achieved. For using user availability as a constraint,

$${\prod }_{i = 1}^{n} {A}_{i} \approx 1 - {\sum }_{i = 1}^{n} {U}_{i}$$

is given. Accordingly, the multiplication of the availability of each related component can be represented by the sum of the user availabilities. According to the current to exemplary embodiment, this expression is applied to an optimization method, and thus pieces of information on availability which differ with user are reflected so that optimized network architecture can be designed.

In this case, object availability information of each user is reflected to design network restoration architecture such that the architecture can have network connection configuration which differs with the availability level of the user.

Consequently, network restoration is performed according to the determined network restoration architecture (operation 54).

The above-described network restoration method can be written as a computer program. The computer program is stored in a computer readable recording medium, and can be implemented in a computer that reads and executes the program. Examples of the computer readable recording medium include magnetic storage media and optical recording media.

According to the present invention, when failure occurs in a network to which various subscribers having different recovery requirements are connected, the network can be promptly recovered from the failure.

Furthermore, optimized network design can be achieved by reflecting availability information and price information of each component in the network.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or to replaced or supplemented by other components or their equivalents. Accordingly, other implementations are within the scope of the following claims.

What is claimed is:

1. A method of restoring a target network to which users having different recovery requirements are connected, the method comprising:
analyzing network components including availability information of each user and parameters reflecting characteristics of the target network; and
determining optimized restoration architecture for the target network based on the result of the analysis.

2. The method of claim 1, wherein the determining of the optimized restoration architecture comprises transforming multiplication of availabilities of individual components which form the target network into a relational expression with respect to a sum of availability of each user and selecting the optimized restoration architecture based on a value obtained from the relational expression.

3. The method of claim 1, wherein the determining of the optimized restoration architecture comprises obtaining availability information of the target network in order to determine the optimized restoration architecture for the target network.

4. The method of claim 3, wherein the availability information of the target network is obtained using multiplication of availabilities of components connected together in series.

5. The method of claim 3, wherein the availability information of the target network is obtained using multiplication of values, each obtained by subtracting an availability value of each component that is connected to other component in parallel from a value of 1.

6. The method of claim 1, wherein the parameters reflecting the characteristics of the target network include unique component information including price information and reliability information of the network component.

7. The method of claim 6, wherein the reliability information is obtained based on mean time to failure (MTTF) of a component which cannot be recovered from failure and mean time to repair (MTTR) of a component which is recoverable from failure.

8. The method of claim 1, wherein the determining of the optimized restoration architecture comprises designing the network restoration architecture by reflecting object availability information of each user such that the network restoration architecture can have network connection configuration that differs with availability level of the user.

9. The method of claim 1, wherein the determining of the optimized restoration architecture comprises selecting restoration architecture which is optimized by use of a mathematical programming scheme, a heuristic scheme or a meta-heuristic scheme.

10. An apparatus for restoring a target network to which users having different recovery requirements are connected, the apparatus comprising:
a network analyzing unit to analyze network components including availability information of each user and parameters reflecting characteristics of the target network; and
an architecture determining unit to determine values necessary for designing optimized restoration architecture for the target network based on the result of the analysis.

11. The apparatus of claim 10, wherein the architecture determining unit transforms multiplication of availabilities of individual components which form the target network into a relational expression with respect to a sum of availability of each user and selects the optimized restoration architecture based on a value obtained from the relational expression.

12. The apparatus of claim 10, wherein the parameters reflecting the characteristics of the target network include unique component information including price information and reliability information of the network component.

13. The apparatus of claim 12, wherein the reliability information is obtained based on mean time to failure (MTTF) of a component which cannot be recovered from failure and mean time to repair (MTTR) of a component which is recoverable from failure.

14. The apparatus of claim 10, wherein the architecture determining unit designs the network restoration architecture by reflecting object availability information of each user such that the network restoration architecture can have a network connection configuration that differs with availability level of the user.
